(19) United States
(12) Patent Application Publication
(10) Pub. No.: US 2004/0181455 A1
(43) Pub. Date: Sep. 16, 2004

(54) System and method for monitoring imports and exports

(76) Inventor: G. Fenghua Zhou, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/799,149

(22) Filed: Mar. 12, 2004

(30) Foreign Application Priority Data
Mar. 12, 2003 (TW) 92105298

(51) Int. Cl. G06F 17/60

(52) U.S. Cl. 705/22

(57) ABSTRACT

A system for monitoring imports and exports includes a number of client computers (10), an enterprise server (12), a customs server (16) and a database (14). The client computers provide interfaces for users to input information and obtain information. The enterprise server audits import and export materials based on information on stocks, automatically generates a bill of entry, and transmits the bill of entry to the customs server. The enterprise server includes a system configuring module, a data maintaining module, a bill of entry generating module, a bill of entry status maintaining module, a customs data synchronizing module, and an auditing module. The database stores configured information, generated bills of entry, and feedback of the customs server. A related method is also disclosed.

### BACKGROUND OF THE INVENTION

1. Field of the invention

The present invention relates to a computer-based system and method for monitoring imports and exports, and particularly to a system and method for monitoring material imports and exports through one or more customs communication networks.

2. Background of the invention

Monitoring material importing and exporting through customs is important for many enterprises, particularly for international traders and manufacturers. However, conventional business management systems and methods have certain shortcomings. A conventional method for monitoring material importing and exporting through customs is disclosed in P.R. China Patent No. CN1,332,426A, issued on Jan. 23, 2002 and entitled Method and System for Managing Imports and Exports Commodity Inspection Number Authentication. This patent discloses a network management system and method regarding an authentication number as a recognizable character. The system comprises: computers of a national and regional Inspection and Quarantine Bureau, computers for consulting and monitoring of number authentication consultation companies, a telephone network connecting with the monitoring computers via modems, a network connecting with the telephone network via network terminals, and computers of national and regional customs. The method facilitates inspecting quantities and directions of flow of commodities by customs, provides users with liberal access to desired data, and efficiently avoids or reduces the loss of national tax revenue. However, the system and method cannot efficiently monitor material importing and exporting through customs.

### SUMMARY OF THE INVENTION

An objective of the present invention is to provide a system for automatically monitoring material importing and exporting through customs.

Another objective of the present invention is to provide a method for automatically monitoring material importing and exporting through customs.

To achieve the first abovementioned objective, the present invention provides a system for automatically monitoring materials importing and exporting through customs. The system preferably comprises: a plurality of client computers for providing interfaces for users to maintain information on import and export materials and stocks; an enterprise server for receiving and handling input information, generating bills of entry, and transmitting the bills of entry to the customs server; a database for storing configured information, the bills of entry and feedback of the customs server. The enterprise server comprises: a system configuring module for initializing the system; a data maintaining module for adding, modifying, inquiring and deleting information on import and export materials and stock; an auditing module for auditing import and export materials based on a current stock of each material, a safe threshold volume of each material, and a consumption quantity per unit finished product; a bill of entry generating module for generating bills of entry based on the audited information on import and export materials, and for transmitting the bills of entry to the customs server; a bill of entry status maintaining module for storing and inquiring of statuses of the bills of entry, the statuses of the bills of entry comprise un-transmitted bill of entry, transmitted bill of entry, and bill of entry which has been fed back by the customs server; a customs data synchronizing module for synchronizing customs information based on the content of feedback from the customs server and updating corresponding bills of entry accordingly.

To achieve the second abovementioned objective, the prevent invention provides a method for automatically monitoring material importing and exporting through customs. The method comprises the steps of: (a) providing a system for monitoring and initializing the system; (b) maintaining information on import and export materials and stocks, the materials including raw materials and finished products; (c) auditing the information on import and export materials based on a current stock of each material, a safe threshold volume of each material, and a consumption quantity per unit finished product corresponding to each raw material, the auditing of the import materials being to ensure that the import quantity of each raw material together with the quantity of the current stock does not exceed the safe threshold volume of the raw material, the auditing of export quantities of finished products being to ensure that the consumption quantity per unit finished product corresponding to each raw material does not exceed the quantity of the current stock of the raw material, if the result of auditing the information on import and export materials is not satisfactory, the procedure goes back to step (b); (d) automatically generating a bill of entry based on the audited information on import and export materials, transmitting the bill of entry to a customs server, and storing the bill of entry in the database, if the result of auditing the information on import and export materials is satisfactory; (e) receiving and storing feedback of the customs server; (f) determining whether the bill of entry needs to be modified as a result of the feedback; and (g) modifying the bill of entry accordingly and synchronizing customs information, if modification is needed.

The system of the present invention can connect with a customs server, obtain correlative information on customs, monitor import and export materials, optimize stocks of a company, reduce mistakes due to human error, improve efficiency, and economize costs of the company. The method of the present invention provides similar advantages.

Other objects, advantages and novel features of the present invention will be drawn from the following detailed description of the present invention with the attached drawings, in which:

### BRIEF DESCRIPTION OF THE DRAWINGS

FIG. 1 is a schematic diagram of hardware configuration of a system for monitoring imports and exports in accordance with the preferred embodiment of the present invention;

FIG. 2 is a block diagram of function modules of the enterprise server of the system of FIG. 1; and

FIG. 3 is a flowchart of a preferred method for monitoring imports and exports in accordance with the present invention.

### DETAILED DESCRIPTION OF THE INVENTION

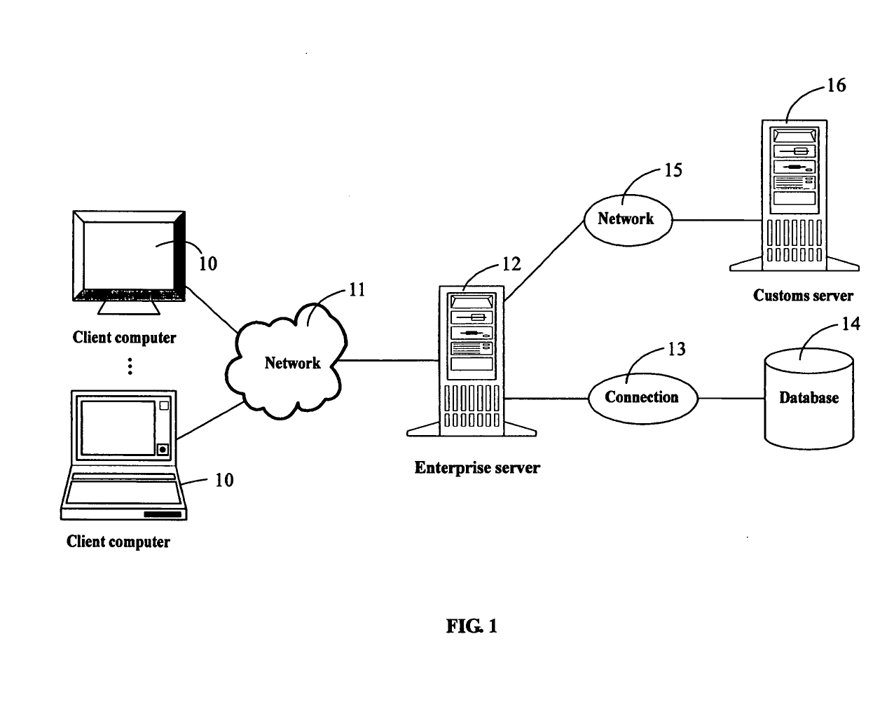

FIG. 1 is a schematic diagram of hardware configuration of a system for monitoring imports and exports in accordance with the preferred embodiment of the present invention. A plurality of client computers 10 is connected with an enterprise server 12 via a network 11. The enterprise server 12 is connected with a database 14 via a connection 13, and is connected with a customs server 16 via a network 15. The networks 11, 15 can jointly or severally be the Internet, an intranet, or another suitable means of electronic communication. The connection 13 is a kind of database connection, which can be an Open Database Connectivity (ODBC), a Java Database Connectivity (JDBC) or another suitable kind of connectivity. The client computers 10 provide interfaces for users to initialize the system and maintain information. The enterprise server 12 stores function modules for receiving and handling input information, and for generating bills of entry and transmitting the bills of entry to the customs server 16. The enterprise server 12 also receives feedback from the customs server 16. The database 14 stores configured import and export material information, stock information, the bills of entry, customs information, customs feedback, and so on. The customs server 16 receives the bills of entry transmitted by the enterprise server 12, and transmits the feedback on the bills of entry to the enterprise server 12.

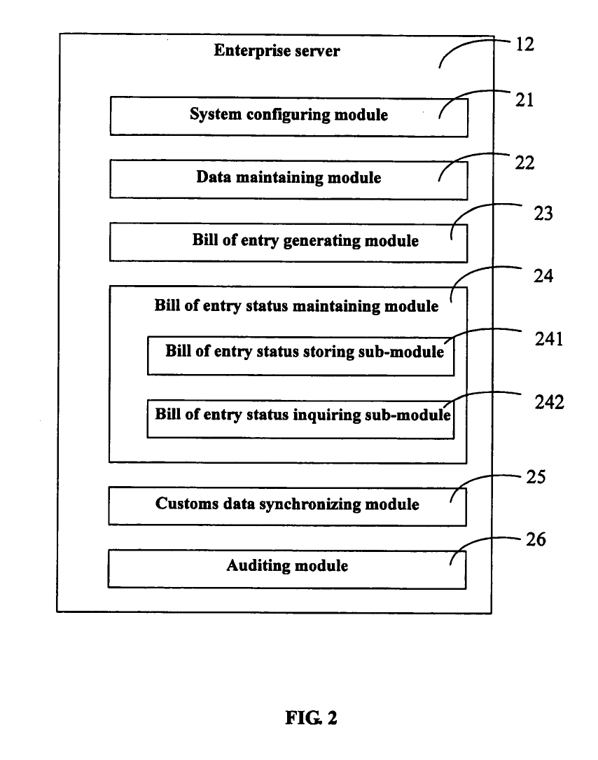

FIG. 2 is a block diagram of function modules of the enterprise server 12. The enterprise server 12 comprises a system configuring module 21, a data maintaining module 22, a bill of entry generating module 23, a bill of entry status maintaining module 24, a customs data synchronizing module 25, and an auditing module 26.

The system configuring module 21 is used for adding and modifying the relevant FTP (File Transfer Protocol), communication, and dial-up information.

The data maintaining module 22 is used for adding, modifying, inquiring and deleting information on import and export materials and stocks. The information on the import and export materials comprises each material's name, quantity, unit price, total price, time of departure, and so on. The information on the stocks comprises: a quantity of each material, the materials including finished products and raw materials; a safe threshold volume of each material; and a consumption quantity per unit finished product corresponding to each raw material.

The bill of entry generating module 23 is used for generating bills of entry, and transmitting the bills of entry to the customs server 16. Each bill of entry is an electronic document based on the audited information on import and export materials.

The bill of entry status maintaining module 24 is used for storing and inquiring of statuses of the bills of entry. The statuses of the bills of entry comprise untransmitted bills of entry, transmitted bills of entry, and bill of entry which have been fed back by the customs server 16. The bill of entry status maintaining module 24 comprises a bill of entry status storing sub-module 241, and a bill of entry status inquiring sub-module 242. The bill of entry status storing sub-module 241 is used for storing the status of each bill of entry in the database 14. The bill of entry status inquiring sub-module 242 is used for inquiring of the status of any bill of entry.

The customs data synchronizing module 25 is used for synchronizing the customs information stored in the database 14 based on the content of feedback from the customs server 16, and updating the corresponding bills of entry accordingly.

The auditing module 26 is used for auditing import and export materials to optimize current stocks of the enterprise. The auditing is based on a current stock of each material, the safe threshold volume of each material, and the consumption quantity per unit finished product corresponding to each raw material. The auditing comprises auditing import quantities of raw materials and export quantities of finished products. The auditing of import quantities of raw materials is to ensure that the import quantity of each raw material together with the quantity of the current stock does not exceed the safe threshold volume of the raw material. The auditing of export quantities of finished products is to ensure that the consumption quantity per unit finished product corresponding to each raw material does not exceed the quantity of the current stock of the raw material.

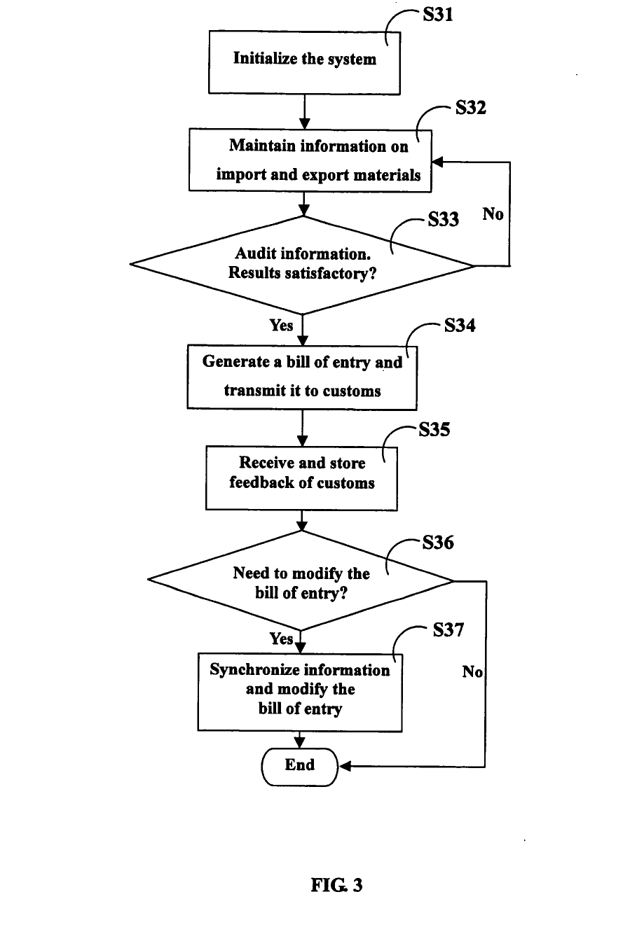

FIG. 3 is a flowchart of a preferred method for monitoring imports and exports. In step S3 1, a user initializes the above-described system for monitoring imports and exports via the system configuring module 21. The initialization comprises adding and modifying an FTP setup, communications setup, dial-up setup, and so on. In step S32, after initializing, the user adds, modifies, inquires and deletes information on import and export materials and stocks via the data maintaining module 22. In step S33, after maintaining, the auditing module 26 audits the information on import and export materials. The auditing is based on a current stock of each material, a safe threshold volume of each material, and a consumption quantity per unit finished product corresponding to each raw material. The auditing of import quantities of raw materials is to ensure that the import quantity of each raw material together with the quantity of the current stock does not exceed the safe threshold volume of the raw material. The auditing of export quantities of finished products is to ensure that the consumption quantity per unit finished product corresponding to each raw material does not exceed the quantity of the current stock of the raw material. The auditing module 26 then determines whether results of the audit are satisfactory. If the results are not satisfactory, the procedure goes back to step S32. If and when the results are satisfactory, in step S34, the bill of entry generating module 23 automatically generates a bill of entry, transmits the bill of entry to the customs server 16, and stores the bill of entry in the database 14. In step S35, the enterprise server 12 receives feedback on the bill of entry from the customs server 16, and stores the feedback in the database 14. In step S36, the enterprise server 12 determines whether the bill of entry needs to be modified as a result of the feedback. If modification is not needed, the procedure is ended. If modification is needed, in step S37, the customs data synchronizing module 25 synchronizes the customs information stored in the database 14 based on the content of the feedback, and modifies the bill of entry accordingly. Thereupon, the procedure is ended.

Although the present invention has been specifically described on the basis of a preferred embodiment and a preferred method, the invention is not to be construed as being limited thereto. Various changes or modifications may be made to said embodiment and methods without departing from the scope and spirit of the invention.

What is claimed is:

1. A system for monitoring imports and exports, the system comprising a plurality of client computers, an enterprise server, a database and a customs server, wherein:
the client computers provide interfaces for users to maintain information on import and export materials and stocks;
the enterprise server receives and handles input information, generates bills of entry, and transmits the bills of entry to the customs server, the customs server comprising:
a data maintaining module for adding, modifying, inquiring and deleting information on import and export materials and stock;
an auditing module for auditing import and export materials based on a current stock of each material, a safe threshold volume of each material, and a consumption quantity per unit finished product;
a bill of entry generating module for generating bills of entry based on the audited information on import and export materials, and for transmitting the bills of entry to the customs server;
the database stores configured information, the bills of entry and feedback of the customs server; and
the customs server receives the bills of entry from the enterprise server, generates feedback of the bills of entry, and transmits the feedback to the enterprise server.

2. The system as described in claim 1, wherein the enterprise server further comprises a system configuring module for initializing the system.

3. The system as described in claim 1, wherein the enterprise server further comprises a bill of entry status maintaining module for storing and inquiring of statuses of the bills of entry.

4. The system as described in claim 1, wherein the enterprise server further comprises a customs data synchronizing module, for synchronizing customs information based on the content of feedback from the customs server and updating corresponding bills of entry accordingly.

5. The system as described in claim 3, wherein the bill of entry status maintaining module comprises:
a bill of entry status storing sub-module for storing statuses of the bills of entry; and
a bill of entry status inquiring sub-module for inquiring of the statuses of the bills of entry.

6. The system as described in claim 5, wherein the statuses of the bills of entry comprise untransmitted bill of entry, transmitted bill of entry, and bill of entry which has been fed back by the customs server.

7. A method for monitoring imports and exports, the method comprising the following steps:
providing a system for monitoring and maintaining information on import and export materials and stocks, the materials including raw materials and finished products;
auditing the information on import and export materials based on a current stock of each material, a safe threshold volume of each material, and a consumption quantity per unit finished product corresponding to each raw material, the auditing of the import materials being to ensure that the import quantity of each raw material together with the quantity of the current stock does not exceed the safe threshold volume of the raw material, the auditing of export quantities of finished products being to ensure that the consumption quantity per unit finished product corresponding to each raw material does not exceed the quantity of the current stock of the raw material; and
automatically generating a bill of entry based on the audited information on import and export materials, transmitting the bill of entry to a customs server, and storing the bill of entry in the database, if the result of auditing the information on import and export materials is satisfactory.

8. The method as described in claim 7, wherein the step of generating a bill of entry further comprises the step of: receiving and storing feedback of the customs server.

9. The method as described in claim 7, wherein the step of generating a bill of entry further comprises the steps of:
determining whether the bill of entry needs to be modified as a result of the feedback; and
modifying the bill of entry accordingly and synchronizing customs information, if modification is needed.

10. The method as described in claim 7, wherein the step of auditing the information on import and export materials is repeated if the result of auditing the information on import and export materials is not satisfactory.

11. A method for monitoring imports and exports, the method comprising the following steps:
providing a system for monitoring and maintaining information on import and materials and stocks, the materials including raw materials;
auditing the information on import materials based on a current stock of each material, a safe threshold volume of each material, the auditing of the import materials being to ensure that the import quantity of each raw material together with the quantity of the current stock does not exceed the safe threshold volume of the raw material; and
automatically generating a bill of entry based on the audited information on import materials, transmitting the bill of entry to a customs server, and storing the bill of entry in the database, if the result of auditing the information on import materials is satisfactory; wherein
the step of auditing the information on import materials is repeated if the result of auditing the information on import materials is not satisfactory.
